(19) United States
(12) Patent Application Publication
(10) Pub. No.: US 2007/0067505 A1
(43) Pub. Date: Mar. 22, 2007

(54) Method and an apparatus to prevent over subscription and thrashing of translation lookaside buffer (TLB) entries in I/O virtualization hardware

(76) Inventors: Narayanan G. Kaniyur, Newark, CA (US); Alexander M. Brown, Mountain View, CA (US); Percy K. Wadia, Sunnyvale, CA (US); Ronald L. Dammann, Palo Alto, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/233,783

(22) Filed: Sep. 22, 2005

(51) Int. Cl. G06F 13/28

(52) U.S. Cl. 710/22

(57) ABSTRACT

A method and an apparatus to prevent over subscription and thrashing of translation lookaside buffer (TLB) entries in I/O virtualization hardware have been presented. In one embodiment, the method includes performing address translation in a direct memory access (DMA) remap engine within an input/output (I/O) hub in response to I/O requests from a root port using a guest physical address (GPA) queue to temporarily hold address translations requests to service the I/O requests and a TLB. The method may further include managing allocation of entries in the TLB to the address translation requests using an allocation window to avoid over-subscription of the entries and managing de-allocation of the entries using a de-allocation window to avoid thrashing of the entries. Other embodiments have been claimed and described.

### TECHNICAL FIELD

Embodiments of the invention relate generally to computing systems, and more particularly, to input/output (I/O) virtualization.

### BACKGROUND

To meet the increasing computing demands of homes and offices, virtualization technology in computing has been introduced recently. In general virtualization technology allows a platform to run multiple operating systems and applications in independent partitions. In other words, one computing system with virtualization can function as multiple “virtual” systems. Furthermore, each of the virtual systems may be isolated from each other and may function independently.

Part of virtualization technology is input/output (I/O) virtualization. In platforms supporting I/O virtualization, address remapping is used to enable assignment of I/O devices to domains, where each domain is considered to be an isolated environment in the platform. A subset of the available physical memory is designated to a domain and I/O devices assigned to that domain are allowed access to the memory allocated. Isolation is achieved by blocking access from I/O devices not assigned to that specific domain.

The system view of physical memory may be different than each domain's view of its assigned physical address space. A set of translation structures provides the needed remapping between the domain's assigned physical address space (also known as guest physical address) to the system physical address (also known as host physical address). Thus a full address translation is a two step process: In the first step, the I/O request is mapped to a specific domain (also known as context) based on the context mapping structures. In the second step, the guest physical address of the I/O request is translated to the host physical address based on the translation structures (also known as page tables) for that domain or context.

Direct memory access (DMA) remapping hardware (also referred to as DMA remap engine) is added to I/O hubs to perform the needed address translations in I/O virtualization. To enable efficient and fast address remapping, translation lookaside buffers (TLB) in DMA remap engine are used to store frequently used address translations. This speeds up an address translation by avoiding long latencies associated with main memory read operations otherwise needed to complete the address translation.

DMA remap engines in a conventional I/O hub includes a queuing structure (also known as GPA queue) to temporarily hold incoming address translation requests (may be referred to as “requests” or “translation requests” hereinafter) from one or more root ports coupled to the I/O devices. Address translation requests are triggered as a result of I/O requests from devices connected to the root ports in the I/O hub. Translation requests are issued by the GPA queue to the TLB and if valid translations are available, the TLB can service the address translations. If the needed address translation is not available, the DMA remap engine performs a page walk and loads the translation into the TLB. A page walk typically includes one or more memory read requests to fetch the needed page table entries from translation mapping tables in main memory to complete the address translation. Note that the latencies for these memory requests may be avoided by designing in caches for these intermediate mapping table entries. Design considerations such as power, die size etc may limit the capacity of the TLB. As a result, the TLB may not be able to store address translations for all translation requests stored in the GPA queue, and hence, over subscription and thrashing may occur as illustrated in the following examples.

FIG. 1 illustrates a TLB 110 and a queuing structure (GPA queue) 120 in a DMA remap engine 102 within a conventional I/O hub 100. Typically, the requests in the queuing structure 120 are sent to the TLB 110 sequentially according to the order of the requests in the queuing structure 120. Each entry in the TLB 110 can map a specific range of memory addresses (e.g., a 4K or 2M region, depending on platform needs). An entry in the TLB 110 may need to be assigned to an incoming translation request if it cannot be serviced by an existing TLB entry. Every request in the queuing structure 120 may potentially need a separate TLB entry as the GPA addresses may all be unique (4K or 2M) memory ranges. Suppose Entry a in the TLB 110 has been assigned to Request A in queuing structure 120. Since the queuing structure 120 holds a larger number of requests than the number of entries in the TLB 110, it is possible when Request J is sent to the TLB 110, all entries in the TLB 110 have already been assigned. According to some conventional practice, the TLB 110 may discard the translations in some of the previously assigned entries in order to free up an entry to allocate to Request J. For instance, the TLB 110 may throw out the translation in Entry a and reassign Entry a to Request J. However, the discarded translation in Entry a is still needed if Request A has not been serviced yet. This problem is referred to as over subscription.

Thrashing is a second problem that may arise out of the above described situation. As described above, the translation in Entry a has been thrown out in order to assign Entry a to Request J before Request A is serviced. Since Request A is ahead of Request J in the queuing structure 120 and requests are serviced in the order the requests are received, Request A has to be serviced before Request J. However, when Request A is serviced, Entry a does not contain the address translation for Request A but has been reassigned to Request J. As a result, the translation in Entry a is discarded and memory operations have to be performed to retrieve the address translation for Request A again. The discarding of the original translation in Entry a for Request A happening even before that translation is used is referred to as thrashing. This directly increases latency of translation and reduces the bandwidth of the associated I/O root ports.

### BRIEF DESCRIPTION OF THE DRAWINGS

Embodiments of the present invention is illustrated by way of example and not limitation in the figures of the accompanying drawings, in which like references indicate similar elements and in which:

FIG. 1 shows a TLB and a queuing structure in a DMA remap engine within a conventional I/O hub;

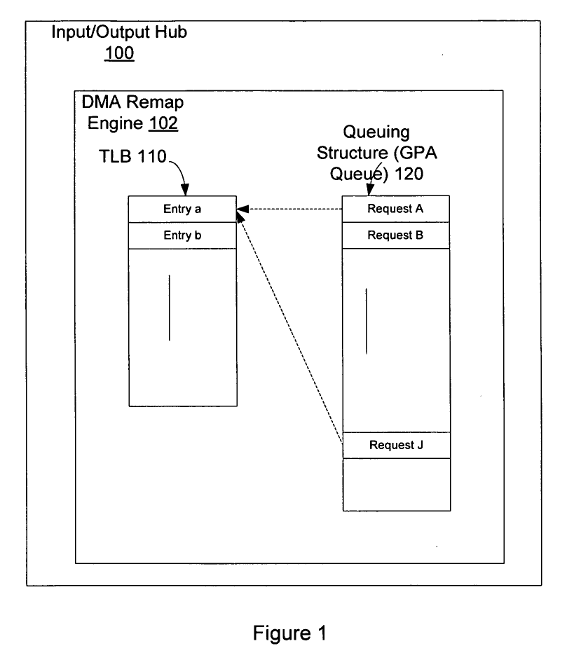

FIG. 2A shows one embodiment of a DMA remap engine and the inbound queue of the associated root port within an I/O hub;

FIG. 2B illustrates one embodiment of an I/O hub;

FIG. 3A shows one embodiment of a process to manage allocation of TLB entries in I/O virtualization hardware using an allocation window;

FIG. 3B shows one embodiment of a process to manage de-allocation of TLB entries in I/O virtualization hardware using a de-allocation window;

FIGS. 4A-4B illustrate a TLB and a GPA queue according to some embodiments of the invention;

FIG. 5 illustrates an exemplary embodiment of a computing system; and

FIG. 6 illustrates an alternative embodiment of the computing system.

### DETAILED DESCRIPTION

A method and an apparatus to prevent over subscription and thrashing of translation lookaside buffer (TLB) entries in I/O virtualization hardware are disclosed. In the following detailed description, numerous specific details are set forth in order to provide a thorough understanding. However, it will be apparent to one of ordinary skill in the art that these specific details need not be used to practice some embodiments of the present invention. In other circumstances, well-known structures, materials, circuits, processes, and interfaces have not been shown or described in detail in order not to unnecessarily obscure the description.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

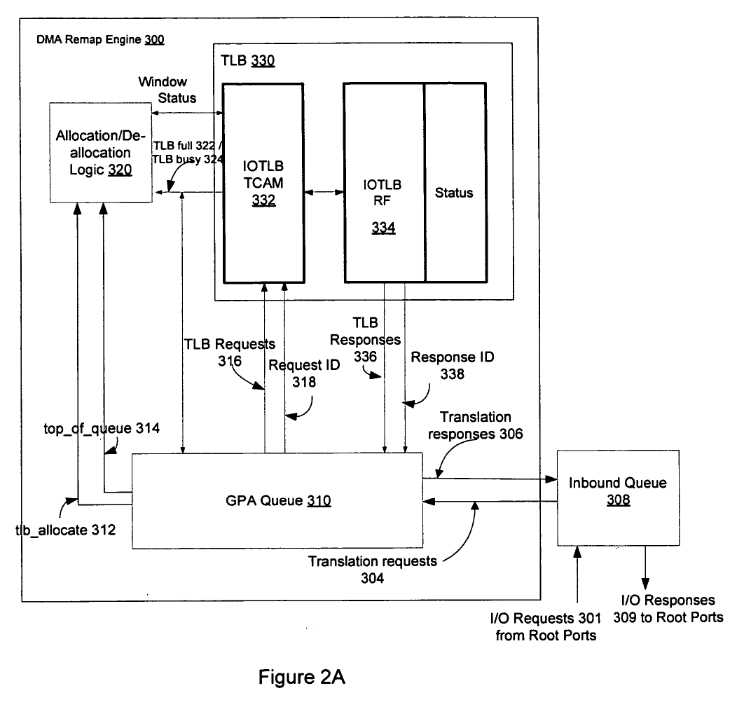

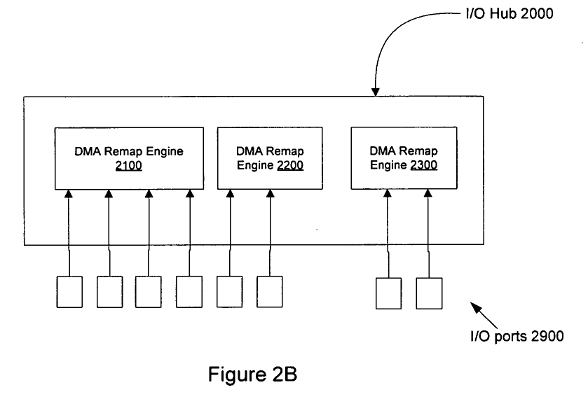

FIG. 2A shows one embodiment of a DMA remap engine and the inbound queue of the associated root port in an I/O hub. The DMA remap engine 300 includes a guest physical address (GPA) queue 310, allocation/de-allocation logic 320, and a translation lookaside buffer (TLB) 330. Note that any or all of the components and the associated hardware illustrated in FIG. 2A may be used in various embodiments of the DMA remap engine 300. However, it should be appreciated that other configurations of the DMA remap engine may include more or less components than those shown in FIG. 2A.

In one embodiment, the inbound queue 308 receives I/O requests 301 from external devices coupled to one or more root ports. The I/O requests may generate address translation requests (also known as translation requests) in the inbound queue 308. The inbound queue 308 is coupled to the GPA queue 310 to forward address translation requests 304 needed to process the incoming I/O requests to the GPA queue 310, where the address translation requests 304 are temporarily held. To temporarily hold the address translation requests 304, the GPA queue 310 may store the address translation requests 304 in a buffer until the address translation requests 304 have been serviced. Then the address translation requests 304 in the buffer may be over-written by other address translation requests 304 arriving at the GPA queue later. The GPA queue 310 is coupled to the TLB 330 and the allocation/de-allocation logic 320. In response to the incoming address translation requests, the GPA queue 310 sends control signals, top_{—of}_queue signal 314 and tlb_allocate signal 312, and TLB requests 316 with request identification 318 (such as, the index of the GPA queue entry) to the allocation/de-allocation logic 320 and the TLB 330, respectively. The TLB requests 318 contain relevant information, such as the guest physical address, the source identifier (also known as Source ID) of the requesting I/O device, and the requesting root port in configurations where the DMA remap engine is shared by multiple root ports. Note that the DMA remap engine may be shared by multiple root ports as illustrated in FIG. 2B. In FIG. 2B, the I/O hub 2000 includes three DMA remap engines 2100-2300, each of which is coupled to some of the I/O ports 2900. The allocation/de-allocation logic 320 is further coupled to the TLB 330 to manage allocation and/or de-allocation of TLB entries to/from the TLB requests 316. In response to the TLB requests 316 from the GPA queue 310, the TLB 330 sends TLB responses 336 with response identification 338 to the GPA queue 310. Based on the TLB responses 336, the GPA queue 310 may send address translation responses 306 to the inbound queue 308 to service the address translation requests 304. After the address translation requests 304 are serviced, the inbound queue 308 may further process the I/O requests as needed.

In some embodiments, the GPA queue 310 is deeper than the TLB 330. Consequently, the TLB 330 may receive more TLB requests 316 to unique (4K or 2M) ranges from the GPA queue 310 than the number of TLB entries in the TLB 330. As discussed in Background, this may lead to over subscription and/or thrashing in the TLB 330. To avoid over subscription and/or thrashing, the allocation/de-allocation logic 320 uses an allocation window and a de-allocation window to manage allocation and de-allocation of TLB entries, respectively. Details of these techniques are described below.

In some embodiments, the TLB 330 includes a tag memory 332 and a register file 334. The tag memory 332 receives TLB requests 316 and holds GPAs of the address translation requests that need to be translated along with the Source ID of the requesting I/O device. The register file 334 holds either the valid translation for the GPA in the corresponding entry in the tag memory 332 or intermediate information needed to complete a page walk to load valid translation for the GPA in the corresponding entry in the tag memory 332. If the address translation of a GPA already exists in the TLB 330, the corresponding page-aligned translated address (also referred to as host physical address (HPA)) may be looked up from the register file 334 at a TLB entry associated with the GPA. If the address translation does not exist, but a page walk is already under way to load the needed, translation, the TLB 330 sends a retry response back to the GPA queue. In both the above cases, the TLB 330 does not have to allocate another TLB entry to the address translation request.

On the other hand, if a TLB request results in a miss in the TLB 330, the TLB 330 attempts to allocate a TLB entry to the address translation request. The GPA of the TLB request may be held in the tag memory 332 at a location associated with the TLB entry allocated. Furthermore, a sequence of cache lookups and/or memory reads may be performed to retrieve the address translation of the GPA. The sequence of cache lookups and/or memory reads is also referred to as a page walk. During the page walk, the intermediate page walk states may be held by the TLB entry allocated.

However, the TLB 330 may not be able to allocate a TLB entry to a TLB request under certain circumstances, and a retry response may be sent back to the GPA queue 310 requesting it to retry later. In one embodiment, the TLB 330 cannot allocate TLB entries when all TLB entries are already allocated to prior translation requests. Alternatively, the TLB 330 cannot allocate TLB entries when the TLB 330 is busy with some other operations related to page walks already in progress. This may happen because of limitations in the ability of the TLB memory structures 332 or 334 to handle multiple operations in the same clock. When all TLB entries are already allocated, the TLB 330 asserts a tlb_full signal 322 to indicate so. Likewise, when the TLB 330 is busy with some other operation and cannot service the current translation request, the TLB 330 asserts a tlb_busy signal 324 to indicate so. Both tlb_full signal 322 and tlb_busy signal 324 may be driven to the allocation/de-allocation logic 320.

In some embodiments, the allocation/de-allocation logic 320 manages the allocation and de-allocation of TLB entries in response to tlb_full signal 322, tlb_busy signal 324, top_of_queue signal 314 and tlb_allocate signal 312. Both tlb_allocate signal 312 and top_of_queue signal 314 may be used to qualify address translation requests in the GPA queue 310. The top-of-queue signal 314 may be implemented using a pointer to indicate that a translation request pointed at by the pointer is the critical one for the associated root port to make forward progress. When an address translation request is sent to the TLB 330 with top_of_queue signal 314 asserted, the allocation/de-allocation logic 320 logically opens an allocation window to allow a TLB entry to be allocated to the address translation request. While the allocation window remains open, the TLB 330 may continue to allocate TLB entries as needed to subsequent address translation requests.

In some embodiments, the tlb_allocate signal 312 is a secondary signal to indicate that the root port associated with an address translation request is restarting the root port's translation request pipeline, which has been halted earlier in response to the tlb_busy signal 324. The tlb_allocate signal 312 may further cause the TLB 330 to start allocating TLB entries if possible.

In one embodiment, the allocation/de-allocation logic 320 closes the allocation window when either tlb_full signal 322 or tlb_busy signal 324 is asserted in response to an address translation request from the GPA queue 310. Once the allocation window is closed, any subsequent address translation request that needs allocation of a TLB entry may be forced to retry till the allocation window is reopened. In one embodiment, the allocation/de-allocation logic 320 logically reopens the allocation window when the root port sends another translation request with either top_of_queue signal 314 or tlb_allocate signal 312 asserted.

In some embodiments, translation requests are tagged with unique request identifiers, which may be included in the request identification 318. These identifiers are returned to the GPA queue 310 with the TLB responses 336 as part of the response identification 338. The GPA queue 310 may use these identifiers to appropriately restart the translation request pipeline when it receives the tlb_busy signal 324 along with the address translation response. Using the request identifiers allows for quick restart of the translation request pipeline when the allocation window is closed due to the TLB 330 being busy.

In addition to managing TLB entry allocation, the allocation/de-allocation logic 320 may manage de-allocation of TLB entries as well. In one embodiment, TLB entries are put into the “lock-down” state upon completion of page walks associated with the TLB entries. Entries in the “lock-down” state cannot be de-allocated and hence the translations associated with these TLB entries are guaranteed to be available in the TLB. A de-allocation window is opened when a translation request is received with top_of_queue signal 314 asserted that results in a hit in the TLB 330. The TLB entry hit by the translation request is moved from the “lock-down” state to the Least Recently Used (LRU) realm. Once the TLB entries are in the LRU realm, they may be de-allocated and a timer based pseudo-LRU algorithm may be used to prioritize TLB entries for de-allocation. Successive requests that hit other TLB entries in the lock-down state cause those entries to be moved to the LRU realm as well.

In some embodiments, the de-allocation window is closed when a translation request results in a miss or hits a TLB entry that has not yet completed its page walk. By closing the de-allocation window, TLB entries in the “lock-down” state that result in hits to incoming translation requests continue to remain in the “lock-down” state. Thus, valid translation in the corresponding TLB entry may be protected from being discarded before the earliest address translation request in the GPA queue is serviced. Thus, the de-allocation window helps to prevent thrashing of TLB entries. In one embodiment, the de-allocation window is reopened when a translation request is received with top_of_queue signal 314 asserted.

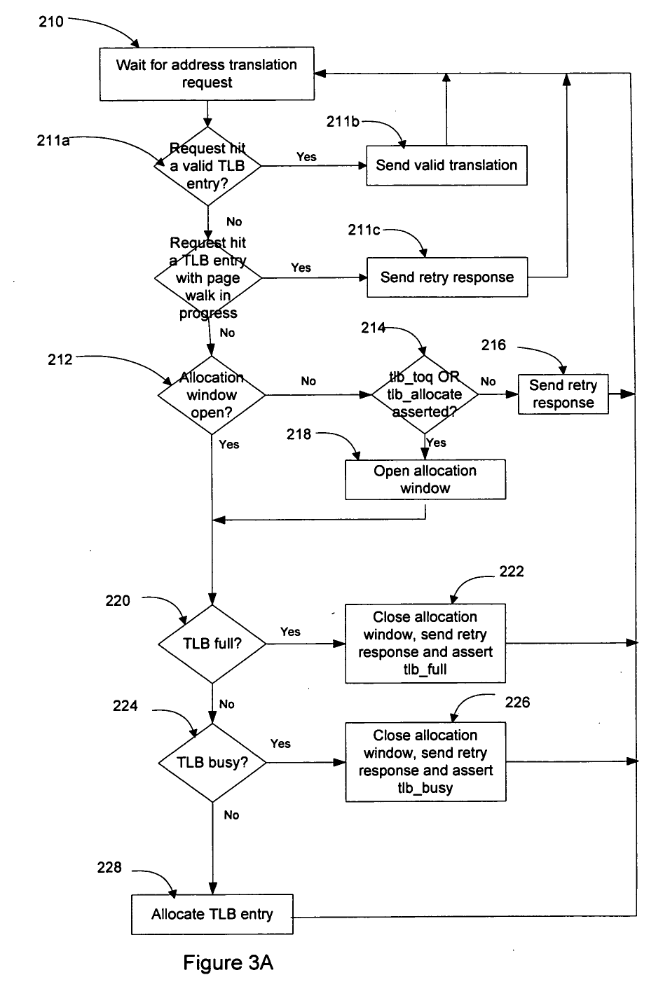

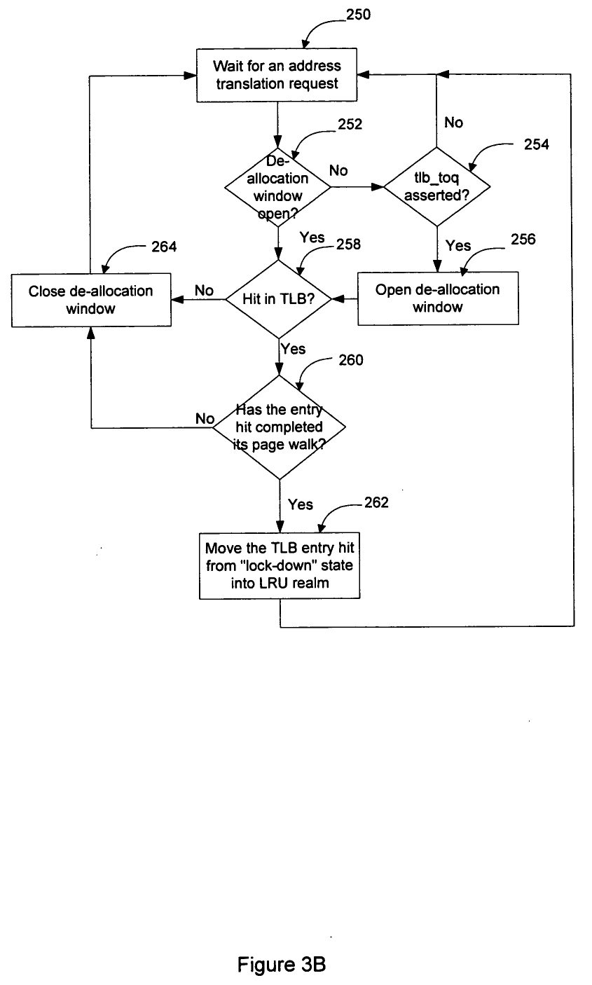

FIG. 3A shows one embodiment of a process to manage allocation of TLB entries in I/O virtualization hardware using an allocation window. The process is performed by processing logic that may comprise hardware (e.g., circuitry, dedicated logic, etc.), software (such as a program operable to run on a general-purpose computer system or a dedicated machine), firmware, or a combination of any of the above.

In one embodiment, processing logic waits for an address translation request from the GPA queue (processing block 210). When processing logic receives an address translation request, it checks if the needed translation already exists in the TLB (processing block 211a). If it does, the translation is sent back to the GPA queue (processing block 211b). If the address translation request hits a TLB entry that still has not completed the needed page walk, the TLB sends a retry response back to the GPA queue (processing block 211c). If the translation request misses the TLB, a new entry needs to be allocated and processing logic checks if allocation window is open (processing block 212). If the allocation window is not open, processing logic checks whether at least one of the signals, top_of_queue (also referred to as tlb_toq) signal or tlb_allocate signal, is asserted (processing block 214). If neither signal is asserted, processing logic sends a retry response to the GPA queue (processing block 216) and transitions back to processing block 210 to wait for another address translation request. On the other hand, if either tlb_toq signal or tlb_allocate signal is asserted, processing logic opens the allocation window (processing block 218) and transitions to processing block 220.

If processing logic determines that the allocation window is open at processing block 212 or processing logic opens the application window at processing block 218, processing logic checks whether the TLB is full (processing block 220). If the TLB is full, processing logic closes the allocation window, sends a retry response to the GPA queue, and asserts the tlb_full signal (processing block 222). Then processing logic transitions back to processing block 210 to wait for another address translation request.

If processing logic determines that the TLB is not full at processing block 220, processing logic checks whether the TLB is busy (processing block 224). If the TLB is busy, processing logic closes the allocation window, sends a retry response to the GPA queue, and asserts the tlb_busy signal (processing block 226). Then processing logic transitions back to processing block 210 to wait for another address translation request. Otherwise, the TLB is neither busy nor full. So processing logic allocates a TLB entry to the address translation request (processing block 228). Then processing logic returns to processing block 210 to wait for another address translation request.

FIG. 3B shows one embodiment of a process to manage de-allocation of TLB entries in I/O virtualization hardware using a de-allocation window. The process is performed by processing logic that may comprise hardware (e.g., circuitry, dedicated logic, etc.), software (such as a program operable to run on a general-purpose computer system or a dedicated machine), firmware, or a combination of any of the above.

In one embodiment, processing logic waits for an address translation request from the GPA queue (processing block 250). When processing logic receives an address translation request, processing logic checks if a de-allocation window is open (processing block 252). If the de-allocation window is not open, processing logic checks whether the tlb_toq signal is asserted (processing block 254). If tlb_toq signal is not asserted, processing logic returns to processing block 250 to wait for another address translation request. If tlb_toq signal is asserted, processing logic opens the de-allocation window (processing block 256). Then processing logic transitions to processing block 258.

Alternatively, if processing logic determines that the de-allocation window is open in processing block 252, processing logic transitions to processing block 258 to check if there is a hit in the TLB. If there is no hit in the TLB, processing logic closes the de-allocation window (processing block 264) and returns to processing block 250 to wait for another address translation request. If there is a hit in the TLB, processing logic checks whether the TLB entry that hit has completed its page walk, and hence, has a valid translation available (processing block 260).

If the TLB entry hit has completed its page walk, processing logic moves the TLB entry hit from the “lock-down” state into the LRU realm (processing block 262) and returns to processing block 250 to wait for another address translation request. Otherwise, processing logic closes the de-allocation window (processing block 264) and returns to processing block 250 to wait for another address translation request.

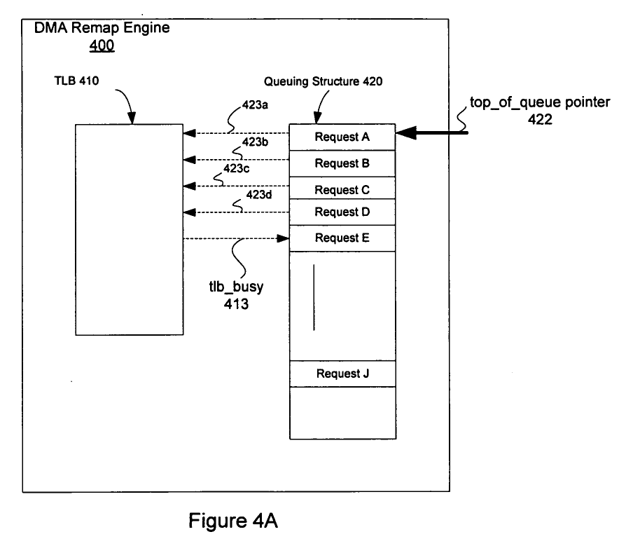

FIGS. 4A-4B illustrate a TLB and a GPA queue in a DMA remap engine within an I/O hub according to some embodiments of the invention. One example of using the allocation window is described below with reference to FIG. 4A. Referring to FIG. 4A, the DMA remap engine 400 includes a TLB 410 and a GPA queue 420. The GPA queue 420 holds a number of address translation requests (e.g., Request A, Request B, etc.). A top_of_queue pointer 422 points to the address translation request on the top of the queue in the GPA queue 420. In the current example, top_of_queue pointer 422 points to Request A.

In one embodiment, the address translation requests are sent to the TLB 410 in first-in-first-out (FIFO) order. Request A 423a is first sent to the TLB 410 with a signal, top_of_queue signal asserted. Because of the asserted top_of_queue signal, the allocation window is opened. In the current example, suppose the TLB 410 is busy with some other operations when the TLB 410 receives Request A 423a. Because the TLB 410 is busy, the TLB 410 closes the allocation window and sends a response with tlb_busy signal 413 asserted to the GPA queue 420. Likewise, the TLB 410 closes the allocation window and sends a response with tlb_full signal asserted to the GPA queue 420 if the TLB 410 is full when the TLB 410 receives Request A 423a.

In one embodiment, the response from the TLB 410 takes four clock cycles to reach the GPA queue 420. As a result, Request B 423b, Request C 423c, and Request D 423d are sent to the TLB 410 following Request A 423a. However, the TLB 410 does not allocate any entries to Requests B, C, and D 423b-423d because the allocation window has been closed already. Thus, Requests B, C, and D 423b-423d may not be serviced by the TLB 410 before Request A 423a is serviced.

By the time the GPA queue 420 is ready to send Request E to the TLB 410, the response with tlb_busy signal 413 or tlb_full signal asserted reaches the GPA queue 420. In response to tlb_busy signal 413 or tlb_full signal, the GPA queue 420 returns to Request A instead of sending Request E to the TLB 410. The GPA queue 420 may send Request A again with top_of_queue asserted to the TLB 410. In response to top_of_queue signal being asserted in conjunction with a translation request, the allocation window may be reopened. After Request A has been serviced by the TLB 410, the top_of_queue pointer 422 is moved to point to the next request in the GPA queue 420, i.e., Request B. As illustrated in the above example, the allocation window together with the top_of_queue pointer 422 may allow the requests in the GPA queue 420 to be serviced by the TLB 410 in the order the requests are held in the GPA queue 420. Furthermore, over subscription of TLB entries may be avoided because TLB entries are not allocated to incoming address translation requests once the allocation window is closed. This forces TLB entries to be allocated only to the first N translation requests to unique 4K ranges, where N is the number of entries in the TLB, irrespective of the depth of the GPA queue.

In addition to the allocation window, a de-allocation may be used in the DMA remap engine 400. One example of using the de-allocation window is described below with reference to FIG. 4B. In the following example, the GPA queue 420 holds two address translation requests, namely, Request A and Request J. Request A is on the top of the queue of requests and the top_of_queue pointer 422 points at Request A.

In one embodiment, Request A 423a with the top_of_queue signal asserted is sent to the TLB 410. In response to the asserted top_of_queue signal, the deallocation window is opened. Suppose Request A 423a results in a miss in the TLB 410, which causes the de-allocation window to be closed. In some embodiments, Entry X 413 in the TLB 410 is allocated to Request A 423a and a page walk is initiated to retrieve the address translation for Request A 423a to be put into Entry X 413. Once the address translation is written into Entry X 413, Entry X 413 is put into the “lock-down” state.

Suppose Request J 423j is sent to the TLB 410 subsequent to Request A 423a and Request J 423j hits the same page as Request A 423a. Thus, Request J 423j results in a hit of Entry X 413 in the TLB 410. However, the de-allocation window has already been closed by the time the TLB 410 receives Request J 423j. Therefore, Entry X 413 may not be moved from the “lock-down” state into the LRU realm to be de-allocated even though Request J 423j results in a hit on Entry X 413. The de-allocation window may be reopened later when the TLB 410 receives another request with the top_of_queue signal asserted. As illustrated in this example, the de-allocation window together with the top_of_queue signal helps to prevent thrashing in the TLB 410 and thus avoids the performance penalty caused by thrashing.

In one embodiment, the DMA remap engine may be shared by multiple root ports within an I/O hub as shown in FIG. 2B. Translation requests are tagged with unique identifiers that specify which of the root ports is generating a particular request. The DMA remap engine implements logic to track unique allocation and de-allocation windows described earlier for each of the root ports. Thus, the TLB resources are managed on a per-port basis to prevent problems of over-subscription and thrashing for all ports.

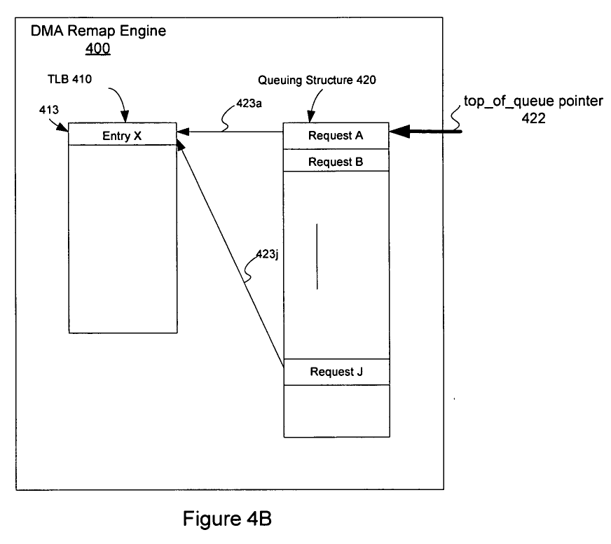

FIG. 5 shows an exemplary embodiment of a computer system 500 usable with some embodiments of the invention. The computer system 500 includes a processor 510, a memory controller 530, a memory 520, an input/output (I/O) hub 540, and a number of I/O ports 550. The memory 520 may include various types of memories, such as, for example, dynamic random access memory (DRAM), synchronous dynamic random access memory (SDRAM), double data rate (DDR) SDRAM, repeater DRAM, etc.

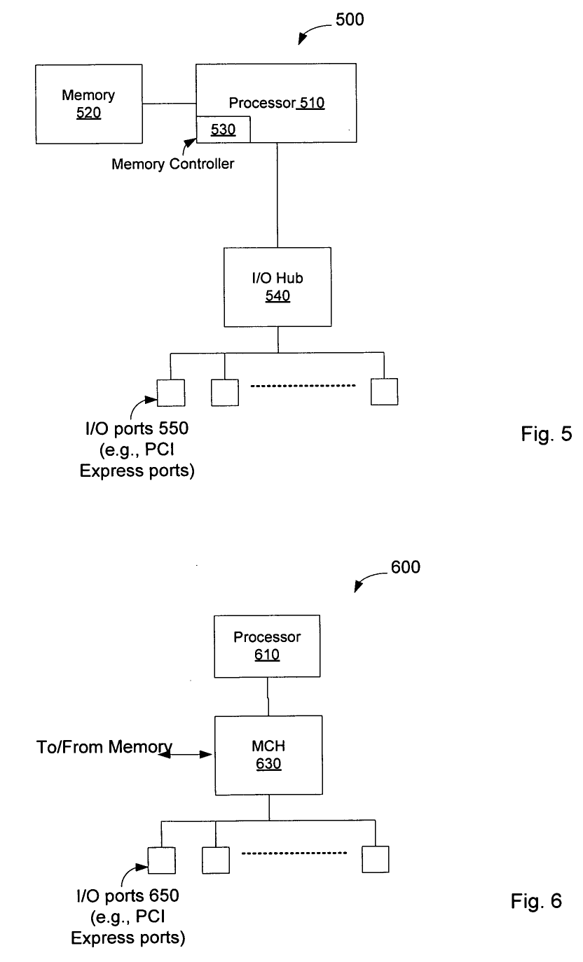

In some embodiments, the memory controller 530 is integrated with the I/O hub 540, and the resultant device is referred to as a memory controller hub (MCH) 630 as shown in FIG. 6. The memory controller and the I/O hub in the MCH 630 may reside on the same integrated circuit substrate. The MCH 630 may be further coupled to memory devices on one side and a number of I/O ports 650 on the other side.

Furthermore, the chip with the processor 510 may include only one processor core or multiple processor cores. In some embodiments, the same memory controller 530 may work for all processor cores in the chip. Alternatively, the memory controller 530 may include different portions that may work separately with different processor cores in the chip.

Referring back to FIG. 5, the processor 510 is further coupled to the I/O hub 540, which is coupled to the I/O ports 550. The I/O ports 550 may include one or more Peripheral Component Interface Express (PCIE) ports. Through the I/O ports 550, the computing system may be coupled to various peripheral I/O devices, such as network controllers, storage controllers, etc. Details of some embodiments of the I/O hub 540 have been described above with reference to FIG. 2A.

In some embodiments, the I/O hub 540 receives address translation requests from the peripheral I/O devices coupled to the I/O ports 550. In response to the I/O requests, the DMA remap engine within the I/O hub 540 performs address translation using a translation lookaside buffer (TLB), an allocation/de-allocation logic module, and a queuing structure (GPA queue) within the I/O hub 540. Details of some embodiments of the DMA remap engine within the I/O hub 540 and some embodiments of the process to manage allocation and de-allocation of TLB entries have been described above.

Note that any or all of the components and the associated hardware illustrated in FIG. 5 may be used in various embodiments of the computer system 500. However, it should be appreciated that other configurations of the computer system 500 may include one or more additional devices not shown in FIG. 5. Furthermore, one should appreciate that the technique disclosed above is applicable to different types of system environment, such as a multi-drop environment or a point-to-point environment. Likewise, the disclosed technique is applicable to both mobile and desktop computing systems.

Some portions of the preceding detailed description have been presented in terms of symbolic representations of operations on data bits within a computer memory. These descriptions and representations are the tools used by those skilled in the data processing arts to most effectively convey the substance of their work to others skilled in the art. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations described herein. This apparatus may be specially constructed for the required purposes, or it may comprise a general-purpose computer selectively activated or reconfigured by a computer program stored in the computer. Such a computer program may be stored in a machine-accessible storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will appear from the description below. In addition, embodiments of the present invention are not described with reference to any particular programming language. It will be appreciated that a variety of programming languages may be used to implement the teachings as described herein.

The foregoing discussion merely describes some exemplary embodiments of the present invention. One skilled in the art will readily recognize from such discussion, the accompanying drawings and the claims that various modifications can be made without departing from the spirit and scope of the subject matter.

What is claimed is:

1. A method comprising:
performing address translation in a direct memory access (DMA) remap engine in response to I/O requests from peripheral I/O devices coupled to one or more root ports using a guest physical address (GPA) queue to temporarily hold address translation requests to service the I/O requests and a translation lookaside buffer (TLB);
managing allocation of entries in the TLB to the address translation requests using one or more allocation windows to avoid over-subscription of the entries; and
managing de-allocation of the entries in the TLB to the address translation requests using one or more de-allocation windows to avoid thrashing of the entries.

2. The method of claim 1, wherein managing allocation of the entries in the TLB using the one or more allocation windows comprises:
opening one of the one or more allocation windows in response to a first address translation request from the GPA queue if one or more predetermined conditions is met;
allocating a first entry in the TLB to the first address translation request;
continuing to allocate entries in the TLB to subsequent address translation requests while the allocation window remains open; and
closing the one of the one or more allocation windows in response to the TLB failing to allocate a second entry to a second address translation request.

3. The method of claim 2, wherein the one or more predetermined conditions includes:
the first address translation request being critical for the root port to make forward progress.

4. The method of claim 2, wherein the one or more predetermined conditions includes:
the GPA queue restarting an address translation request pipeline after receiving a busy signal from the TLB in response to a prior address translation request.

5. The method of claim 1, wherein managing de-allocation of the entries in the TLB using the one or more de-allocation windows comprises:
opening one of the one or more de-allocation windows when the TLB receives a third address translation request that results in a hit in the TLB and the third address translation request being on top of the GPA queue;
closing the one of the one or more de-allocation windows when the TLB receives a fourth address translation request that results in a miss in the TLB; and
preventing de-allocation of entries hit by subsequent address translation requests while the one of the one or more de-allocation windows is closed.

6. The method of claim 5, wherein the GPA queue is deeper than the TLB.

7. The method of claim 1, wherein the translation requests are tagged with unique request identifiers.

8. The method of claim 7, further comprising:
sending the unique request identifiers with address translation responses corresponding to the address translation requests back to the GPA queue.

9. The method of claim 1, wherein each of the one or more allocation windows is designated to each of the one or more root ports and each of the one or more de-allocation windows is designated to each of the one or more root ports.

10. A machine-accessible medium that provides instructions that, if executed by a processor, will cause the processor to perform operations comprising:
performing address translation in a direct memory access (DMA) remap engine in response to I/O requests from external devices coupled to a root port using a translation lookaside buffer (TLB);
managing allocation of entries in the TLB to the address translation requests using an allocation window to avoid over-subscription of the entries; and
managing de-allocation of the entries in the TLB using a de-allocation window to avoid thrashing of the entries.

11. The machine-accessible medium of claim 10, wherein managing allocation of the entries in the TLB using the allocation window comprises:
opening the allocation window in response to a first address translation request from a guest physical address (GPA) queue if one or more predetermined conditions is met;
allocating a first entry in the TLB to the first address translation request;
continuing to allocate entries in the TLB to subsequent address translation requests while the allocation window remains open; and
closing the allocation window in response to the TLB failing to allocate a second entry to a second address translation request.

12. The machine-accessible medium of claim 10, wherein managing de-allocation of the entries using the de-allocation window comprises:
opening the de-allocation window when the TLB receives a third address translation request that results in a hit in the TLB and the third address translation request being on top of a guest physical address (GPA) queue temporarily holding the address translation requests; and
closing the de-allocation window when the TLB receives a fourth address translation request that results in a miss in the TLB; and
preventing de-allocation of entries hit by subsequent address translation requests while the de-allocation window is closed.

13. An apparatus comprising:
a translation lookaside buffer (TLB) to hold a plurality of entries;
a queuing structure coupled to the TLB to send address translation requests to the TLB; and
a logic module coupled to the TLB and the queuing structure to manage allocation of the plurality of entries to the address translation requests using an allocation window and to manage de-allocation of the entries from the address translation requests using a de-allocation window.

14. The apparatus of claim 13, wherein the queuing structure comprises:
a guest physical address (GPA) queue coupled to the TLB and the logic module; and
an inbound queue coupled to the GPA queue.

15. The apparatus of claim 14, wherein the GPA queue is deeper than the TLB.

16. The apparatus of claim 14, wherein the GPA queue uses a pointer to identify an address translation request on top of the GPA queue.

17. A system comprising:
a memory;
a memory controller coupled to the memory; and
an input/output (I/O) hub coupled to the memory controller, wherein the I/O hub comprises
a translation lookaside buffer (TLB) to hold a plurality of entries,
a queuing structure coupled to the TLB to send address translation requests to the TLB, and
a logic module coupled to the TLB and the queuing structure to manage allocation of the plurality of entries to the address translation requests using an allocation window and to manage de-allocation of the entries from the address translation requests using a deallocation window.

18. The system of claim 17, wherein the queuing structure comprises:
a guest physical address (GPA) queue coupled to the TLB and the logic module; and
an inbound queue coupled to the GPA queue.

19. The system of claim 18, wherein the GPA queue is deeper than the TLB.

20. The system of claim 17, further comprising a processor coupled to the memory controller.

21. The system of claim 20, wherein the memory controller and the processor reside on a single integrated circuit substrate.
